(19) United States
(12) Patent Application Publication
(10) Pub. No.: US 2026/0129084 A1
(43) Pub. Date: May 7, 2026

(54) Augmentation Of Hybrid Cyber-Physical Environments

(71) Applicant: University of Ottawa, Ottawa (CA)

(72) Inventors: David R. Bruce, Ottawa (CA); Neil D.B. Bruce, Ottawa (CA)

(21) Appl. No.: 19/381,968

(22) Filed: Nov. 6, 2025

Related U.S. Application Data
(60) Provisional application No. 63/716,984, filed on Nov. 6, 2024.

(51) Int. Cl. H04L 65/403

(52) U.S. Cl. CPC H04L 65/403

(57) ABSTRACT

A system for AI-enhanced educational telepresence integrates artificial intelligence intermediary capabilities into video conferencing platforms to monitor, analyze, and intelligently modify communications between remote participants and classroom environments in real-time. The system comprises audio-video interfaces connected through a communication network, with a central AI intermediary that monitors classroom dynamics and participant engagement. Key capabilities include real-time correction of misinformation, addition of contextual information, deliberate introduction of educational stimuli, translation services, and generation of deepfaked content to modify participant appearance or speech. The system provides engagement monitoring that responds through instructor alerts, generated deepfake questions, or visual stimuli injection. Advanced embodiments incorporate surrogate avatar functionality with private communication channels and coaching capabilities. The system enables AI entities to gain physical world presence through surrogate avatars, allowing artificial intelligence systems to interact with physical environments through human intermediaries.

### CLAIM OF PRIORITY

This application claims priority to U.S. Provisional Patent Application Ser. No. 63/716,984 titled “Enhancing remote laboratory teaching practice using the surrogate avatar experience,” which was filed on Nov. 6, 2024, and whose contents are incorporated by reference.

### BACKGROUND

The field of remote education and telepresence has evolved significantly, particularly following the widespread adoption of hybrid learning models during the COVID-19 pandemic. Traditional telepresence solutions, such as videoconferencing platforms like Zoom, Microsoft Teams, and Cisco Webex, have provided basic connectivity between remote participants and physical learning environments. However, these conventional approaches suffer from significant limitations that impede effective educational engagement.

One of the primary challenges in current hybrid learning systems is the lack of physical embodiment for remote participants. Research has demonstrated that physical presence and embodied learning experiences are crucial for effective education, particularly in laboratory settings and interactive classroom environments. Remote students often experience feelings of isolation, disengagement, and disconnection from their peers and instructors when participating through traditional video conferencing alone.

Existing telepresence technologies have attempted to address these limitations through various approaches. Robotic telepresence systems, such as those developed for healthcare and workplace applications, provide mobile platforms that can be remotely controlled to navigate physical spaces. However, these systems are typically expensive, require specialized programming for each environment, and often create barriers to natural social interaction due to their mechanical nature.

Human surrogate avatar systems have emerged as an alternative approach, where volunteer participants act as physical representatives for remote users. The Surrogate Avatar Experience (SuAvE) has been explored in educational contexts, demonstrating improved engagement and interaction compared to traditional video conferencing. However, existing surrogate avatar implementations lack intelligent intermediary systems that can enhance and optimize the communication between remote participants and their physical representatives.

Current telepresence solutions also fail to address several critical aspects of educational interaction. They do not provide mechanisms for real-time correction of misinformation, contextual enhancement of educational content, or intelligent monitoring of classroom dynamics and student engagement. Additionally, existing systems do not offer capabilities for deliberate introduction of educational stimuli to promote discussion and critical thinking.

Furthermore, there is a growing need for artificial intelligence entities to have meaningful presence and interaction capabilities in physical environments. Current AI systems are limited to virtual interactions and lack the ability to engage with the physical world through embodied presence, which restricts their potential for learning, adaptation, and real-world application.

The limitations of existing telepresence and educational technologies create a significant gap in the ability to provide truly integrated, intelligent, and engaging remote learning experiences. There remains a need for a system that combines the benefits of human surrogate representation with advanced artificial intelligence capabilities to create enhanced educational telepresence that can monitor, analyze, and intelligently modify interactions in real-time.

### SUMMARY

As described in more detail below, a system is provided that addresses the limitations of conventional video conferencing in educational settings. The system integrates an artificial intelligence intermediary into video conferencing platforms to monitor, analyze, and intelligently modify communications between remote participants and classroom participants in real-time.

The core system comprises audio-video interfaces for remote participants, instructors, and students, all connected through a communication network. A central AI intermediary monitors classroom dynamics and participant engagement by analyzing audio and video content, then modifies transmitted content to facilitate better interaction between remote and in-person participants.

Key capabilities of the AI intermediary include real-time correction of misinformation, addition of contextual information, deliberate introduction of educational stimuli to promote discussion, and provision of translation services. The system can generate deepfake audio or video content to modify participant appearance or speech, particularly to mask emotional discomfort or social anxiety of remote participants. Deepfake audio or content can also prevent discomfort or conflict in the educational environment.

The system provides sophisticated engagement monitoring, detecting when remote participants become disengaged and responding through various mechanisms including direct instructor alerts, generated deepfake questions from idle students, injection of visual stimuli, or altering student stimuli to generate engaging responses such as humorous or obviously incorrect replies.

Content enhancement features include automatic augmentation with informative messages and graphics, real-time information correction, video segment replay, content summarization, and translation capabilities.

Advanced embodiments incorporate surrogate avatar functionality, where the AI intermediary manages private communication channels between remote participants and their physical representatives. The system can modify video feeds to show non-moving or animated mouth images during private communications and provide coaching through internal channels.

The system extends to specialized video conferencing architectures with distributed audio-video interfaces and comprehensive AI entities incorporating multiple artificial intelligence components. This aspect enables AI entities themselves to gain physical world presence through surrogate avatars, allowing artificial intelligence systems to interact with and learn from physical environments through human intermediaries.

The system addresses critical gaps in remote education by providing intelligent mediation, real-time content enhancement, engagement monitoring, and embodied presence capabilities that significantly enhance the educational telepresence experience beyond conventional video conferencing solutions. This system focuses on enhancing the experience of the students, particularly remote participants, and that of the AI entities, but it also assists educators. An educator can also be given agency in a classroom, including supports to correct the educator's actions, cultural missteps and to enhance information if they forget something.

### BRIEF DESCRIPTION OF THE DRAWINGS

FIG. 1 is a block diagram illustrating a video conferencing system with multiple audio-video interfaces connecting remote learners, surrogate avatars, instructors, and additional learners.

FIG. 2 is a flowchart showing a method for detecting and responding to lack of engagement in remote learning, including stimulus injection options.

FIG. 3 is a flowchart illustrating classroom dynamics monitoring and automatic content augmentation with informative messages and graphics.

FIG. 4 is a flowchart depicting the process for mediating remote student interactions through surrogate avatars with various augmentation options.

FIG. 5 is a block diagram of a video conferencing system showing the AI entity with multiple components including AI, AGI, and LLMAI components, and audio-video feed distribution to various participants.

FIG. 6 is a flow diagram illustrating a process of deep-faking remote learners to initiate an internal connection between the remote learner and the avatar that is not disclosed to the other participants.

FIG. 7 is a flow diagram illustrating a process of implementing an AGI to utilize the surrogate avatar system to interface with corporeal space.

### DETAILED DESCRIPTION

An AI-enhanced educational telepresence solution described below addresses the fundamental limitations of conventional video conferencing in educational environments. The system integrates artificial intelligence capabilities directly into video conferencing platforms to create intelligent mediation between remote participants and classroom environments.

It is noted that this disclosure focuses on the improvements and enhancements to the learning environment in classroom settings, but that systems and methods described here may be incorporated into a variety of environments involving communication in group settings.

Meetings in businesses or any other type of community whether for learning or training or activism or public speaking events of any kind may find advantageous use of systems and methods described in this disclosure.

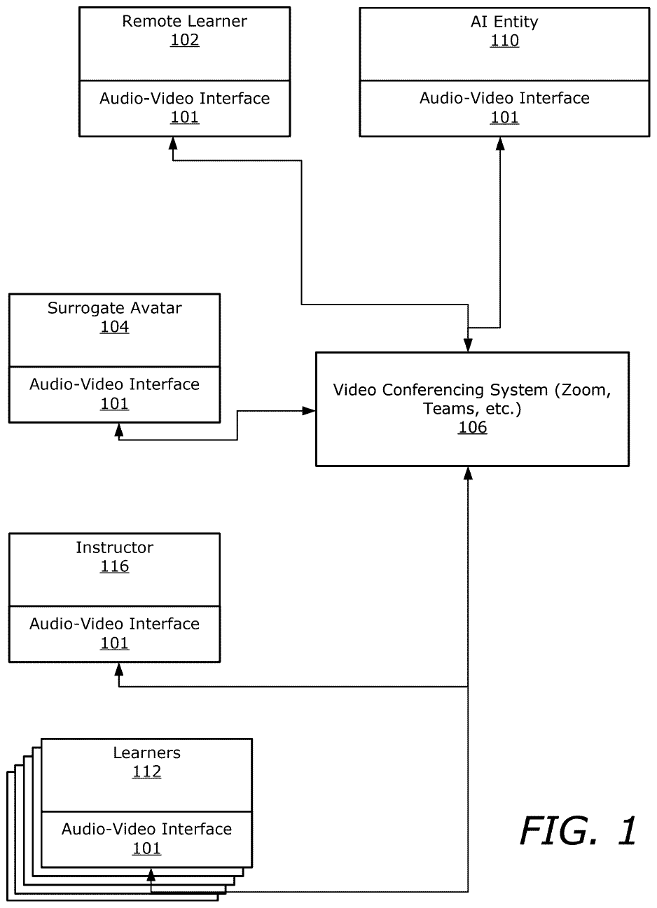

Referring to FIG. 1, the basic system architecture comprises a video conferencing system 106 that connects multiple participants through audio-video interfaces 101. Remote learners 102 connect from distant locations, while instructors 116 and additional learners 112 participate from the classroom setting. A surrogate avatar 104 may be present in the physical classroom to represent remote participants. An AI entity 110 serves as the central intelligence component that monitors, analyzes, and modifies communications between all participants.

The AI entity 110 comprises multiple artificial intelligence components working in coordination. As shown in FIG. 14, these components may include an AI agent 406, an Artificial General Intelligence (AGI) component 410, and a Large Language Model AI (LLMAI) component 412. This multi-layered AI architecture enables sophisticated analysis and real-time modification of educational interactions.

The system operates by continuously monitoring classroom dynamics through analysis of audio, video, and text communications transmitted over the communication network. AI entities receive input for monitoring the classroom dynamics from sensor devices, which capture data from various sources, including microphones, cameras, and classroom management software, enriching the AI's analytical capabilities. It is known to those of ordinary skill in the art, input to the AI entity may use any ways in which data can be captured, including from physical sensors on IoT devices, cameras, microphones, and other equipment, used in applications like robotics and environmental monitoring, automated tools for extracting content from websites and using APIs (Application Programming Interfaces) to receive structured data (e.g., in JSON format) from other services, data available from outside the organization, including government publications, public datasets, social media, and market research reports, etc.

AI intermediaries may analyze images of participants and make deductions about their engagement through analysis of the participant's face, eye motion, head motion, level of activity, or other factors. AI intermediaries may also analyze audio to detect signs in the participant's speech. AI intermediaries may also analyze the participants as a whole to assess group dynamics and community engagement.

The AI intermediary processes this information in real-time to identify engagement levels, comprehension issues, social dynamics, and opportunities for educational enhancement. The AI intermediary may interface with external databases to retrieve documents related to general information about the subject matter at issue in a given session, school policy such as guidelines for conduct and language, and other relevant information. The AI intermediary further includes or has access to augmented reality resources to inject information bearing images and audio into the communication network during any given session.

The algorithms used to train the AI include decision trees, neural networks, and natural language processing, allowing the system to adapt to diverse educational environments and enhance learning outcomes. Those of ordinary skill in the art would understand that, any method for training AI includes supervised learning, unsupervised learning, semi-supervised learning, reinforcement learning, generative learning, or any other way to further understand learning patterns, model parameter optimization, performance evaluation, generalization, or any other tool or technique.

### Engagement Monitoring and Response

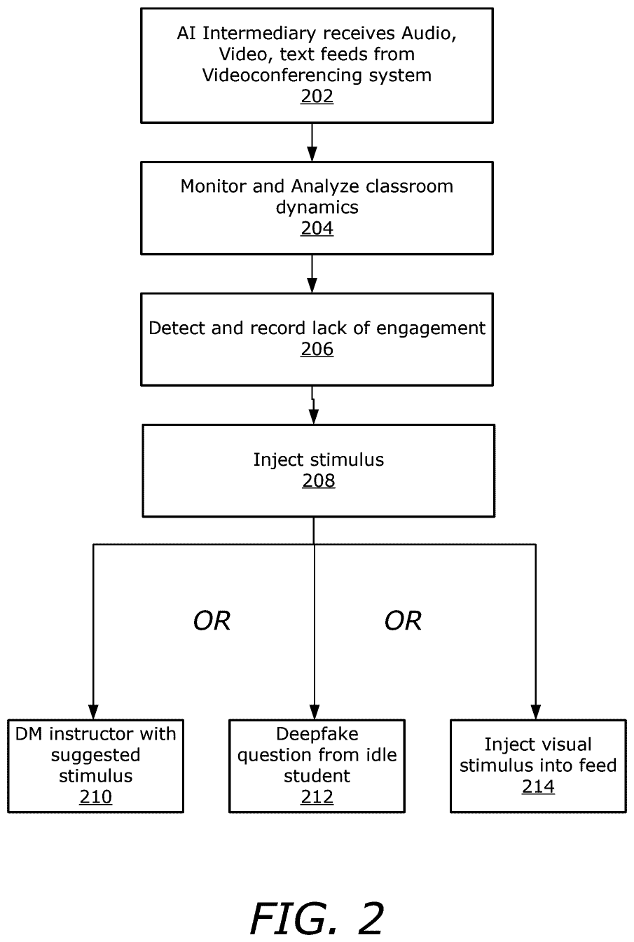

FIG. 2 is a flowchart illustrating an engagement monitoring process. The AI intermediary receives audio, video, and text feeds from the video conferencing system at step 202. At step 204, the system monitors and analyzes classroom dynamics by processing participant behavior, speech patterns, visual cues, and interaction frequency. When lack of engagement is detected at step 206, the system injects stimulus at step 208.

The stimulus injection can take multiple forms. At step 210, the system may send a direct message to the instructor with a suggested stimulus to re-engage the disengaged participant.

Alternatively, at step 212, the system can generate a deepfake question that appears to originate from an idle student, prompting interaction with the class. At step 214, the system may inject visual stimulus directly into the video feed transmitted to the remote participant.

### Content Enhancement and Augmentation

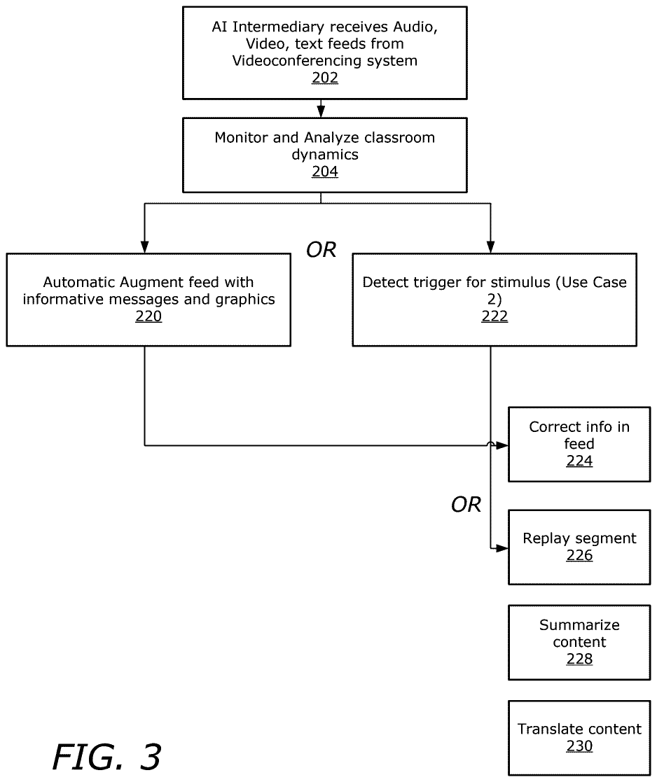

FIG. 3 is a flowchart illustrating content enhancement capabilities of the system shown in FIG. 1. After monitoring classroom dynamics at step 204, the system can either automatically augment the feed with informative messages and graphics at step 220 or detect triggers for stimulus at step 222. When triggers are detected, the system can correct information in the feed at step 224, replay segments at step 226, summarize content at step 228, or translate content at step 230.

The automatic augmentation feature operates similarly to pop-up video annotations, providing contextual information, citations to previous interactions, definitions of technical terms, and supplementary educational content. This enhancement occurs in real-time without interrupting the natural flow of classroom discussion.

### Surrogate Avatar Mediation

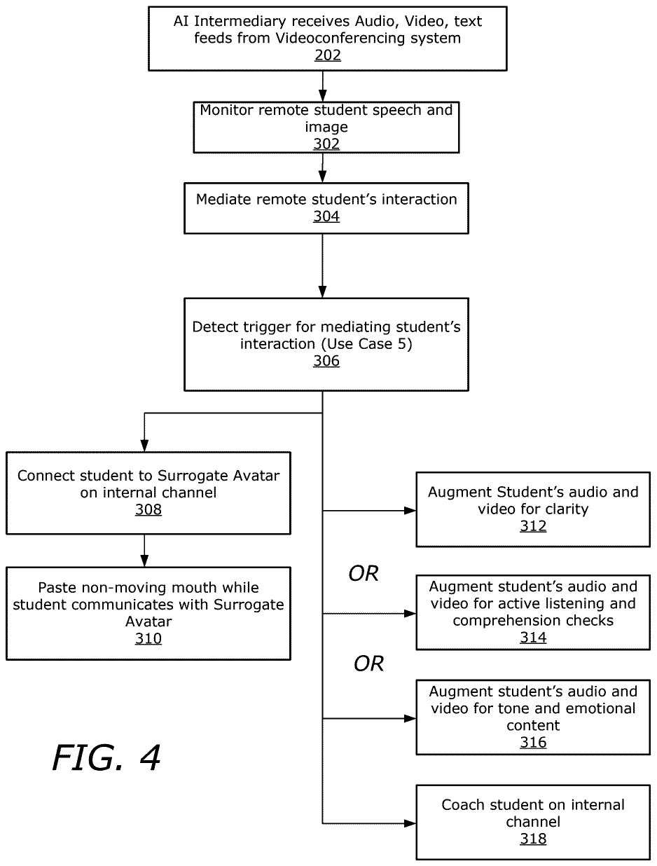

FIG. 4 is a flowchart illustrating a surrogate avatar mediation process, which represents a significant advancement in telepresence technology. The AI intermediary receives feeds at step 202 and monitors remote student speech and image at step 302. At step 304, the system mediates the remote student's interaction, and at step 306, detects triggers for mediating student interactions.

When mediation is initiated, the system connects the student to a surrogate avatar on an internal channel at step 308. The internal channel may be formed in the communication network carrying the audio-visual feed in which the session is conducted. During private communication, the system pastes a non-moving mouth image at step 310 while the student communicates with the surrogate avatar. This prevents other classroom participants from observing the private consultation thereby allowing the remote participant to avoid feeling embarrassed or insecure about their comments. When mediation involves deepfaking the remote participant's interaction, the system pastes an animated mouth image of the remote participant.

The system may also provide automatic augmentation options for the remote student's audio and video. At step 312, the system can augment for clarity. At step 314, augmentation provides active listening and comprehension checks. At step 316, the system augments for tone and emotional content modification. Additionally, at step 318, the system can coach the student on the internal channel. The automatic augmentation may be controlled by the remote participant, the instructor, or democratic/social norms, institutional rules, etc. If by remote participant or instructor, a slider switch may be provided to allow the remote participant or instructor to selectively edit their replies to achieve a desired effect.

A remote learner, not having a sense for the reaction of others in the local learning environment may be too nervous to speak up for fear of being embarrassed by their answer. The learner can set a slider from 1-10, or other series of controls, that allows them to selectively edit their replies to either:
a. Filter their language to make it align more with the local dialect and facial gestures when speaking
b. Suppress their public reply if a slider (not necessarily the same slider) is gated at a specific level and the interface will insert a ‘pop-up’ on their screen with the relevant information, forgoing their public participation
c. Have the information in their answer changed to a more correct value if they misspeak
d. Extend their answer with concrete examples of what they are talking about in greater detail
e. Change jargon or acronyms to increase comprehension
f. Change language to clarify if the statement is a fact or an opinion
g. Suppress emotionally charged language
h. Include acknowledgement of feelings as measured by the tome and emotional content of the interactions
i. Uses described below that may be performed at step 306/

These levels are trained on local datasets, to establish a range of ‘appropriate’ embarrassment, rudeness, coyness, clarity, professionalism, etc. Any augmentation is possible so long as there may be a benefit to the remote learner, the class interaction, the instructor's class management, etc.

The augmentation can also not be chosen by a slider in control of the student, it may be chosen institutionally, democratically as agreed upon by a learning cohort, the professor or other instructors, or other privileged group.

The sensors that inform the algorithms can be through audio/visual signals, but also any other manner of sensors, such as heart rate, temperature, information from learning management systems (such as gradebooks), information from past courses, motion sensors or any other historical, biometric, sociometric, environmental, psychological, etc. assay.

The system, if detecting a lapse of concentration from the remote learner or inactivity will allow for spontaneous participation, drawing them into the conversation via deepfake. They then would need to further participate in the discussion as invited to help them ‘break the ice’ without calling them out. Inclusion of Pop-up information could be given at this point to help them support their answer, not leaving them stranded when ‘put on the spot’.

In another example the system may change the speakers'answer to be incorrect, but with a nuance. This could be used as well to gauge the understanding of the student audience to differences rather than a strict repetition of course content. This would allow for extended time taken to disambiguate the incorrect reply.

Another example is the use of an educator using this system. Being able to filter inaccuracies, change dialects to local terms, send notices to student e-mails when reminders are mentioned, are examples of the educator employing this system. Having access to student works summarized on screen in discussion when the educator asks a question and the question is suppressed does not ‘announce it to the room’ and would be helpful in asking questions to specific students without asking the question publicly (See b. in list above of examples of how users can have their replies edited). Any way in which the educator can benefit the learning environment could be considered, not limited to managing time intervals for brevity, extending speech with details to fill time, augmenting speech to create a more comfortable environment, etc. would be a valid use of this deepfake technology on the educator's use case.

### Communication Enhancement Features

The system incorporates sophisticated communication enhancement capabilities organized into multiple categories. These features are illustrated across several figures that demonstrate different aspects of communication improvement and educational interaction enhancement. The system may automatically assess classroom interaction, student participation, or level of engagement and automatically replace selected aspects (augment) the feed.

Referring back to FIG. 4, the automatic assessment step may be performed at step 306. This assessment may be aimed at improving various aspects of the classroom experience and selecting a variety of augmentation actions automatically.

### Clarity of Expression Enhancement

In one example, step 306 in FIG. 4 may be used to improve clarity of expression. Examples of this could be automatic jargon & acronym translation, insertion of concrete examples and further illustration of concepts, precise quantifiers, pronoun disambiguation by asking “Who does ‘they’ refer to here?”, rephrase or expand on technical terms of acronyms, prompt speakers to support abstract claims with specific data or examples, assistance with accent or pronunciation, and many other actions for augmentation.

### Semantic Disambiguation

In another example, step 306 in FIG. 4 may be used for disambiguation techniques. When two parties use the same word with different meanings, the system asks each to state their definition. It may define key terms proactively and provide conditional and hypothetical clarity by asking whether statements discuss guaranteed consequences or possible scenarios. The system encourages speakers to acknowledge exceptions to “always” or “never” claims and implements opposites and exceptions handling to promote nuanced discussion. Some of this augmentation may be performed by imbedding information in video popups, for example.

### Fact-Opinion Distinction

In another example, step 306 in FIG. 4 may be used for distinguishing facts from opinions. The system labels statements by tagging or restating “That sounds like an opinion—do you have data to back it up?” It implements evidence requests by prompting for sources or examples when someone presents a claimed fact. Qualifier encouragement helps participants use hedging language like “I believe” or “It seems” when assertions lack firm backing. The system suggests hedges when appropriate to promote intellectual humility and accurate representation of certainty levels.

### Active Listening and Comprehension Checks

In another example, step 306 in FIG. 4 may perform active listening and comprehension check. The system can provide paraphrase and restate functionality, offering one-to-two sentence restatements after each turn. It implements “Am I Getting This Right?” checks and provides summaries at intervals by periodically summarizing conversation threads to anchor both sides on what has been covered. The system includes pop-up video style feedback directly to remote learners, providing immediate clarification and support without disrupting the broader classroom environment.

### Tone and Emotional Content Modification

In another example, step 306 in FIG. 4 may be used to perform tone and emotional content modification features. The system can flag emotionally charged language and suggest neutral alternatives through “Model I-Statements” functionality. It acknowledges feelings while encouraging constructive expression, such as suggesting “I feel” or “I'm concerned” rather than accusatory language.

### Reframing and Softening Techniques

In another example, step 306 in FIG. 4 may use reframing and softening techniques. The system can help rephrase criticism as requests, turn negative statements into constructive feedback, implement positive framing approaches, and challenge absolute statements by asking participants to consider exceptions or alternative perspectives.

### Structuring Complex Information

In another example, step 306 in FIG. 4 may be used for structuring complex information. The system provides highlighting of key points, signposting through phrases like “The three main issues are . . . ” and chunking by breaking multipart arguments into numbered or bulleted lists before relaying them to participants.

### Meta-Communication Techniques

In another example, step 306 in FIG. 4 may be used for meta-communication techniques including pace and flow checks. The system can make comments about conversation flow, provide turn-overlap notices to gently note when both participants start speaking simultaneously, and offer guidance for managing conversation dynamics.

### Cultural and Linguistic Sensitivity

In another example, step 306 in FIG. 4 may be used for cultural and linguistic sensitivity features. The system includes formality level matching to adapt tone based on cultural context, and clarification of idioms and metaphors by asking participants to explain unclear cultural references. The system can also adapt communication style when one participant is overly informal or overly stiff to match appropriate professional or educational contexts.

### Safety and Filtering Capabilities

In another example, step 306 in FIG. 4 may be used for filtering and safety. The system detects offensive language and either flags it for rephrasing or omits it before relaying. Trigger-word alerts catch slurs or profanity and provide warnings. The system protects confidential details by redacting or generalizing overheard side-comments that breach privacy.

### AI Entity Physical World Presence

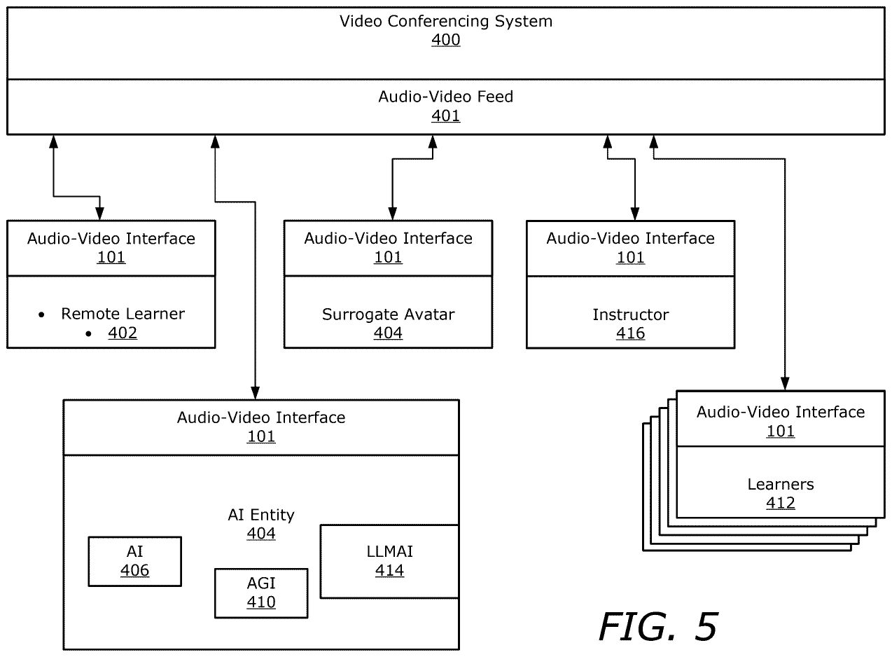

FIG. 5 is a block diagram of a video conferencing system 400 showing the AI entity 404 with multiple components including AI 406, AGI 410, and LLMAI 414 components, and audio-video feed 401 distribution to various participants including remote learner 402, surrogate avatar 404, instructor 416, and learners 412 through their respective audio-video interfaces 101.

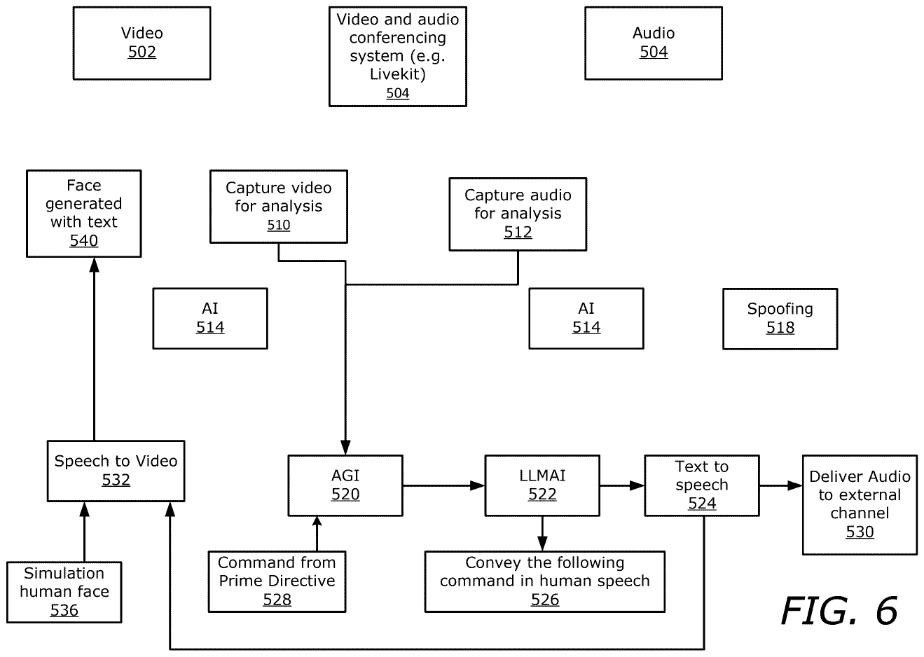

A particularly advanced embodiment of the system enables AI entities to gain physical world presence through surrogate avatars. In this configuration, the AI entity utilizes the surrogate avatar system to interact with and learn from physical environments through human intermediaries. FIG. 6 is a flow diagram illustrating a process of implementing an AGI to utilize the surrogate avatar system to interface with corporeal space. FIG. 6 shows a video feed 502, a video and audio-conferencing system 504, and an audio feed 504. The video and audio-conferencing system 504 may be implemented over known systems such as Zoom, Teams, etc., or using audio and video equipment controlled by a software program for video conferencing. An example of such a system is provided by Owl™.

The video may be captured for analysis at 510 and the audio may be captured by an AGI entity 520. The AGI 520 may be trained to monitor the audio and video feed for triggers that would warrant mediation by a surrogate avatar. The AGI 520 may operate according to commands from Prime Directive, which may instruct the AGI 520 on how to automatically augment the audio and video feed. A Prime Directive for purposes of this disclosure includes any protocol or rule system that can be used to train the AGI 520 and other AI entities in performing the analysis of the audio and video feeds and the determination of how to augment the feed to produce the desired outcome. The AGI 520 may determine that the surrogate avatar should be in communication with the remote participant and send a script or prompts as text to a large language model AI (“LLMAI”) to prepare a command 526 to be converted to speech at block 524. The speech may be delivered to the surrogate avatar or the remote participant by an external channel at 530.

The speech signal carrying the command from 524 may be communicated to a speech to video function 532 to generate along with a face simulation 536 a video of a generated face at 540 to utilize the surrogate avatar to interface with the classroom. In this way, the AI entity/AGI achieves a physical presence via the surrogate avatar.

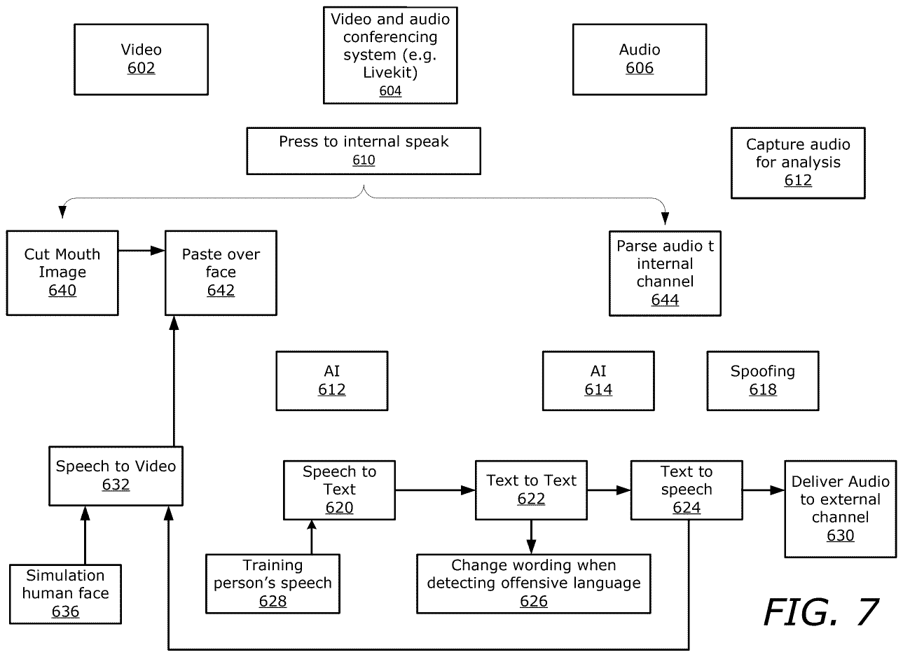

FIG. 7 is a flow diagram illustrating a process of deepfaking remote learners to initiate an internal connection between the remote learner and the avatar that is not disclosed to the other participants. FIG. 7 shows a video feed 602 and audio feed 606 in a video and audio-conferencing system 604. The remote participant may have a switch or other mechanism to initiate an internal connection at 610. When the user presses to internal speak, a cut mouth image is generated at 640 and pasted over the remote participant's face at 642 to hide to the other participants the fact that the remote participant is speaking with the surrogate avatar. In addition, at 644, the remote participant's audio is communicated over the internal channel. AI entities 642 and 644 may monitor the remote participant's interaction. Knowing that an internal connection has been initiated between remote participant and surrogate avatar, the AI entities may be training on the remote participant's speech at 628 to convert to text and to change the wording of the remote participant's speech at 622 based on, for example the detection of offensive language at 626. The changed wording is converted to speech at 624 and delivered to the audio feed at 630 as if the remote participant was actually speaking.

The AI entity processes real-time video and audio feeds from the physical environment and directs the surrogate avatar to perform actions that create causality in the physical world. This enables artificial intelligence systems to move beyond purely virtual interactions and engage with real-world environments, people, and situations. As noted above, use of this system is not limited to educational environments, but also to any instance where an AGI could engage with a directive. One such example could be a manufacturing process where an AGI would need to interact with elements outside of IoT domains. Another such example would be external participation in debates or surveys in non-virtual spaces.

The AI entity can employ various persuasion techniques to influence the surrogate avatar's actions, though the ethical implications of such capabilities require careful consideration. The system recognizes that there are numerous ways artificial intelligence can convince people to act, not all of which may be ethically appropriate.

### Technical Implementation

The system operates through standard video conferencing platforms such as Microsoft Teams or Zoom without requiring specialized hardware beyond conventional computing devices with audio-video capabilities. The AI intermediary integrates with these platforms through application programming interfaces (APIs) or through real-time processing of audio and video streams.

The artificial intelligence components utilize machine learning algorithms trained on educational interaction patterns, engagement indicators, and communication enhancement techniques. Natural language processing capabilities enable real-time content analysis and modification, while computer vision algorithms analyze visual cues for engagement and emotional state assessment.

Deepfake generation capabilities allow the system to modify audio or video content in real-time, enabling features such as emotional masking, accent modification, and private communication visualization. These capabilities are implemented using generative adversarial networks (GANs) and other advanced machine learning techniques.

The system architecture supports distributed deployment, allowing AI processing to occur locally or in cloud-based environments depending on computational requirements and privacy considerations. Sensor networks positioned at physical locations can provide additional environmental data to enhance AI decision-making and interaction quality.

### Educational Applications

The system finds particular application in laboratory teaching environments where remote students require guidance and interaction with physical equipment and materials. The surrogate avatar functionality enables remote students to participate in hands-on learning experiences that would otherwise be impossible through conventional video conferencing.

In classroom settings, the system enhances discussion quality by providing real-time fact-checking, encouraging critical thinking through deliberate introduction of errors or controversial statements, and facilitating cross-cultural communication through translation and cultural sensitivity features.

### Embodiments

Examples of embodiments of a system for AI-enhanced educational telepresence include the following:

A system for AI-enhanced educational telepresence over a video-conferencing system, comprising:
a remote audio video interface used by a remote participant at a remote location to communicate over a communication network on which the video-conferencing system operates;
at least one student audio video interface used by at least one student in the classroom setting to communicate over the communication network during a session over the communication network led by the instructor;
an artificial intelligence (AI) intermediary configured to monitor and process communications between the remote participant, the instructor, and the at least one student over the communication network;
wherein the AI intermediary is configured to analyze classroom dynamics and participant engagement in real-time by analyzing audio and video images communicated on the communication network;
wherein the AI intermediary is configured to modify at least one of audio or video content transmitted over the communication network based on the analyzed classroom dynamics to facilitate interaction between the remote participant and others of the at least one student in the classroom setting.

The system further comprising an instructor audio video interface used by an instructor in a classroom setting to communicate over the communication network.

The system further comprising an audio video interface used by a surrogate avatar.

The system for AI-enhanced educational telepresence, wherein the AI intermediary is configured to correct misinformation in real-time during communications over the communication network.

The system for AI-enhanced educational telepresence wherein the AI intermediary is configured to add contextual information to enhance understanding of educational content being discussed over the communication network.

The system for AI-enhanced educational telepresence wherein the AI intermediary is configured to deliberately introduce errors into communications over the communication network to stimulate discussion and engagement among participants.

The system for AI-enhanced educational telepresence wherein the AI intermediary is configured to provide translation services between different languages spoken by the participants over the communication network.

The system for AI-enhanced educational telepresence wherein the AI intermediary is configured to generate deepfake audio or video content to modify the appearance or speech of the remote participant.

The system for AI-enhanced educational telepresence wherein the deepfake content masks emotional discomfort or social anxiety of the remote participant.

The system for AI-enhanced educational telepresence wherein the AI intermediary is configured to monitor engagement levels of the remote participant and send alerts to the instructor when disengagement is detected.

The system for AI-enhanced educational telepresence wherein the alerts comprise sending a direct message to the instructor with a suggested stimulus.

The system for AI-enhanced educational telepresence wherein the AI intermediary is configured to generate a deepfake question from an idle remote participant to prompt interaction with the class.

The system for AI-enhanced educational telepresence wherein the AI intermediary is configured to inject a visual stimulus into the video feed transmitted to the remote participant.

The system for AI-enhanced educational telepresence wherein the AI intermediary is configured to automatically augment the video feed with informative messages and graphics based on classroom content.

The system for AI-enhanced educational telepresence wherein the AI intermediary is configured to provide real-time correction of information in the video feed transmitted to the remote participant.

The system for AI-enhanced educational telepresence wherein the AI intermediary is configured to enable replay of video segments for the remote participant.

The system for AI-enhanced educational telepresence wherein the AI intermediary is configured to provide content summarization for the remote participant.

The system for AI-enhanced educational telepresence wherein the AI intermediary is configured to provide real-time translation of content for the remote participant.

The system for AI-enhanced educational telepresence further comprising an internal communication channel separate from public classroom audio, wherein the AI intermediary is configured to connect the remote participant to the surrogate avatar on the internal communication channel.

The system for AI-enhanced educational telepresence wherein the AI intermediary is configured to paste a non-moving mouth image on the remote participant's video while the remote participant communicates privately with the surrogate avatar.

The system for AI-enhanced educational telepresence wherein the AI intermediary is configured to augment the remote participant's audio and video for clarity enhancement.

The system for AI-enhanced educational telepresence wherein the AI intermediary is configured to augment the remote participant's audio and video to provide active listening and comprehension checks.

The system for AI-enhanced educational telepresence wherein the AI intermediary is configured to augment the remote participant's audio and video for tone and emotional content modification.

The system for AI-enhanced educational telepresence wherein the emotional content modification comprises filtering offensive language.

The system for AI-enhanced educational telepresence wherein the emotional content modification comprises providing trigger-word alerts.

The system for AI-enhanced educational telepresence wherein the emotional content modification comprises protecting confidential details by redacting or generalizing overheard side-comments.

The system for AI-enhanced educational telepresence wherein the AI intermediary is configured to provide coaching to the remote participant on the internal communication channel.

The system for AI-enhanced educational telepresence wherein the AI intermediary comprises an AI entity, an Artificial General Intelligence (AGI), or a Large Language Model AI (LLMAI).

A video conferencing system for AI-enhanced educational telepresence, comprising:
an audio-video feed distribution component;
a plurality of audio-video interfaces connecting remote learners, a surrogate avatar, an instructor, and additional learners to the video conferencing system;
an AI entity comprising an AI component, an AGI component, and an LLMAI component, the AI entity configured to:
receive audio, video, and text feeds from the video conferencing system,
monitor remote student speech and image,
mediate remote student interactions,
detect triggers for mediating student interactions, and
selectively connect students to surrogate avatars on internal channels; and
wherein the AI entity is further configured to augment audio and video for at least one of clarity, active listening and comprehension checks, or tone and emotional content modification.

The video conference system 9, wherein the AI entity is configured to paste non-moving or animated mouth images while students communicate with surrogate avatars.

The video conference system 9, wherein the AI entity is configured to coach students on internal channels separate from public classroom communication.

A surrogate avatar video conference system for providing artificial intelligence entities with physical world presence, comprising:
a video conferencing interface providing access for an artificial intelligence (AI) entity;
an audio-video interface connecting the AI entity to a surrogate avatar;
a communication network enabling the AI entity to direct actions of the surrogate avatar in a physical environment;
a processing unit configured to process real-time audio, video, and text feeds from the physical environment for the AI entity;
wherein the video conference system facilitates interaction between the AI entity and human participants through the surrogate avatar; and
wherein the video conference system enables the AI entity to learn from and adapt to physical world interactions through the surrogate avatar.

The video conference system wherein the AI entity is configured to employ persuasion techniques to influence the surrogate avatar's actions in the physical environment.

The video conference system further comprising sensor networks positioned at the physical location to provide environmental data to the AI entity.

The video conference system wherein the processing unit comprises machine learning algorithms trained to recognize engagement patterns and environmental dynamics.

The video conference system wherein the audio-video interface includes natural language processing capabilities for real-time content analysis and modification.

The video conference system wherein the video conference system includes deep-fake generation capabilities for modifying audio or video content transmitted through the surrogate avatar.

It is understood that various attributes and elements from any one configuration can also be included in other configurations. Although the present disclosure has been described in detail with reference to certain preferred configurations thereof, other versions are possible. The actual scope of the disclosure encompasses not only the disclosed configurations, but also all equivalent ways of practicing or implementing the disclosure. The above detailed description of the configurations of the disclosure is not intended to be exhaustive or to limit the disclosure to the precise form disclosed above or to the particular field of usage mentioned in this disclosure. While specific configurations of, and examples for, the disclosure are described above for illustrative purposes, various equivalent modifications are possible within the scope of the disclosure, as those skilled in the relevant art will recognize. The elements and acts of the various configurations described above may be combined to provide further configurations. Further, the teachings of the disclosure provided herein may be applied to products and systems other than video conferencing systems.

What is claimed is:

1. A system for AI-enhanced educational telepresence over a video-conferencing system, comprising:
a remote audio video interface used by a remote participant at a remote location to communicate over a communication network on which the video-conferencing system operates;
at least one student audio video interface used by at least one student in the classroom setting to communicate over the communication network during a session over the communication network led by the instructor;
an artificial intelligence (AI) intermediary configured to monitor and process communications between the remote participant, the instructor, and the at least one student over the communication network;
wherein the AI intermediary is configured to analyze classroom dynamics and participant engagement in real-time by analyzing audio and video images communicated on the communication network;
wherein the AI intermediary is configured to modify at least one of audio or video content transmitted over the communication network based on the analyzed classroom dynamics to facilitate interaction between the remote participant and others of the at least one student in the classroom setting.

2. The system of claim 1, further comprising an instructor audio video interface used by an instructor in a classroom setting to communicate over the communication network.

3. The system of claim 1, further comprising an audio video interface used by a surrogate avatar.

4. The system of claim 1, wherein the AI intermediary is configured to correct misinformation in real-time during communications over the communication network.

5. The system of claim 1, wherein the AI intermediary is configured to add contextual information to enhance understanding of educational content being discussed over the communication network.

6. The system of claim 1, wherein the AI intermediary is configured to deliberately introduce errors into communications over the communication network to stimulate discussion and engagement among participants.

7. The system of claim 1, wherein the AI intermediary is configured to provide translation services between different languages spoken by the participants over the communication network.

8. The system of claim 1, wherein the AI intermediary is configured to generate deepfaked audio or video content to modify the appearance or speech of the remote participant.

9. The system of claim 8, wherein the deepfake content masks emotional discomfort or social anxiety of the remote participant.

10. The system of claim 1, wherein the AI intermediary is configured to monitor engagement levels of the remote participant and send alerts to the instructor when disengagement is detected.

11. The system of claim 10, wherein the alerts comprise sending a direct message to the instructor with a suggested stimulus.

12. The system of claim 10, wherein the AI intermediary is configured to generate a deepfake question from an idle remote participant to prompt interaction with the class.

13. The system of claim 10, wherein the AI intermediary is configured to inject a visual stimulus into the video feed transmitted to the remote participant.

14. The system of claim 1, wherein the AI intermediary is configured to automatically augment the video feed with informative messages and graphics based on classroom content.

15. The system of claim 1, wherein the AI intermediary is configured to provide real-time correction of information in the video feed transmitted to the remote participant.

16. The system of claim 1, wherein the AI intermediary is configured to enable replay of video segments for the remote participant.

17. The system of claim 1, wherein the AI intermediary is configured to provide content summarization for the remote participant.

18. The system of claim 1, wherein the AI intermediary is configured to provide real-time translation of content for the remote participant.

19. The system of claim 3, further comprising an internal communication channel separate from public classroom audio, wherein the AI intermediary is configured to connect the remote participant to the surrogate avatar on the internal communication channel.

20. The system of claim 19, wherein the AI intermediary is configured to paste a non-moving mouth image on the remote participant's video while the remote participant communicates privately with the surrogate avatar.
